(19) United States
(12) Patent Application Publication
(10) Pub. No.: US 2015/0147997 A1
(43) Pub. Date: May 28, 2015

(54) EVENT BASED LOCATION-BASED SERVICE

(71) Applicant: AT&T Intellectual Property I, L.P., Atlanta, GA (US)

(72) Inventors: Venson M. Shaw, Kirkland, WA (US); Sangar Dowlatkhah, Alpharetta, GA (US)

(73) Assignee: AT&T Intellectual Property I, L.P., Atlanta, GA (US)

(21) Appl. No.: 14/090,811

(22) Filed: Nov. 26, 2013

(51) Int. Cl. H04W 64/00; G01S 5/00; H04W 4/22

(52) U.S. Cl. CPC H04W 64/00; H04W 4/22; G01S 5/0036
USPC 455/404.2; 455/456.1

(57) ABSTRACT

An event based location-based service may provide a location of a device to members of group(s) associated with the device. A network server may receive an indication of an event from an event notification system. Upon receiving the indication of the event, the network server may determine a region of the event and a location of the device within the region. Upon determining the region of the event and the location of the device, the network server may determine an entity associated with the device. Upon determining the entity associated with the device, the network server may determine communication address for the group(s). The network server may provide the location of the device to the members of group(s) via the communication address.

### TECHNICAL FIELD

The technical field generally relates to location-based services, and more specifically relates to determining a location of a device based on an occurrence of an event.

### BACKGROUND

When an event occurs, such as an earthquake, storm, etc., it is not uncommon for those interested in the wellbeing of an individual within proximity of the event to want to know if the individual is okay. When an event occurs, however, those interested in the wellbeing of the individual may not know if the individual is within proximity of the event. Also, when an event occurs, it may be advantageous to know who may provide assistance to an individual within proximity of the event.

### SUMMARY

An event based location-based service may provide a location of a device to an entity or a group. The location of the device may be provided regardless of whether the device is turned on and/or available. For example, when an event such as earthquake occurs, a server located in a cellular network may receive an indication of the event. Responsive to the indication of the event, the server may determine a region of the event and update a user profile database. The server may update user profiles of uses whose devices are located in the determined region. User profile data may include information about users, locations, subscriptions, billing history, call history, etc.

Upon updating user profile database, the server may determine the location of the device in the region affected by the event. The server may determine an entity or a group to be notified about the location of the device. The entity or group may be associated with the device based on the user profile database. For example, the server may determine the entity or members of group based on recent call history between the entity/members and the device prior to the event. Upon determining the entity/members, the server may send location information about the device to the entity/members.

### BRIEF DESCRIPTION OF THE DRAWINGS

Aspects of an event based location-based service are described more fully herein with reference to the accompanying drawings, in which example embodiments are shown. In the following description, for purposes of explanation, numerous specific details are set forth in order to provide an understanding of the various embodiments. However, the instant disclosure may be embodied in many different forms and should not be construed as limited to the example embodiments set forth herein. Like numbers refer to like elements throughout.

FIG. 1 is a diagram of an example system and process for implementing event driven location-based services.

FIG. 2 is another diagram of an example system and process for implementing event driven location-based services.

FIG. 3 is another diagram of an example system and process for implementing event driven location-based services.

FIG. 4 is a flow diagram of an example process for providing a location of a device to members of group(s) associated with the device.

FIG. 5 is a flow diagram of an example process for determining members of group(s) associated with the device.

FIG. 6 is a block diagram of an example user profile database.

FIG. 7 is a block diagram of an example communication device that may be utilized to implement and/or facilitate event driven location-based services.

FIG. 8 is a block diagram of an example network device (entity) that may provide event driven location-based services.

FIG. 9 is a diagram of an example communications system in which event driven location-based services as described herein may be implemented.

FIG. 10 is a system diagram of an example WTRU.

FIG. 11 is a system diagram of an example RAN and an example core network.

FIG. 12 depicts an overall block diagram of an example packet-based mobile cellular network environment, such as a GPRS network, within which event driven location-based services may be implemented.

FIG. 13 illustrates an architecture of a typical GPRS network within which event driven location-based services may be implemented and/or communicate with.

FIG. 14 illustrates an example block diagram view of a GSM/GPRS/IP multimedia network architecture within which event driven location-based services may be implemented.

FIG. 15 illustrates a PLMN block diagram view of an example architecture in which event driven location-based services may be implemented.

### DETAILED DESCRIPTION OF ILLUSTRATIVE EMBODIMENTS

An event based location-based service may provide a location of a device to an entity or a group associated with the device. A network server may receive an indication of event from an event notification system, or the like. Upon receiving the indication, the network server may determine the region of the event and the location of the device within the region. Upon determining the region and the location of the device, the network server may update a user profile database and determine the entity or group associated with the device based on the user profile database. Once the entity or group is identified, the network server may provide the location of the device to the entity or members of the group.

In an example embodiment, when an event such as earthquake, flood, hurricane, or tornado occurs, a network server located in a cellular network may receive an indication of the emergency event from event notification systems such as Federal Emergency Management Agency (FEMA). Upon receiving the indication of the emergency event, the network server may determine a region of the emergency event. For example, the network server may recognize the region of the emergency event by receiving disaster area information from FEMA. The disaster area may be determined or declared by the event notification systems such as FEMA.

Upon determining the region of the emergency event, the network server may update the user profiles of uses whose devices are located in the region of the emergency event. The user profile database may be located in Home Location Register (HLR) or Home Subscriber Server (HSS) in a cellular network. The user profile database may include information about the users, locations of the user devices, or subscriptions such as billing or calling history.

Upon updating user profile database, the network server may determine whether the location of the device is geographically proximate to the region of the emergency event. For example, the network server may compare the location of the device to the region, and determine whether the device is within the region. The location of the device may be stored on the user profile database. The location of the device may also be obtained by requesting new location update.

Upon determining that the location of the device is within the region, the network server may determine members of group associated with the device based on the user profile database. The network server may analyze various information to determine the association. For example, the information may include users' personal information, location information of devices in the region of the event, subscriptions of the users, or the like. The information may be stored on the user profile database. In some embodiments, the network server may use any combination of the personal information, the location information, and/or the subscription information.

Upon determining the members of group, the network server may provide location information of the device to the members of group. For example, the network server may transmit the location information of the device using SMS/MMS, email, or Google map. The format of the location information may be tailored depending on the type of devices.

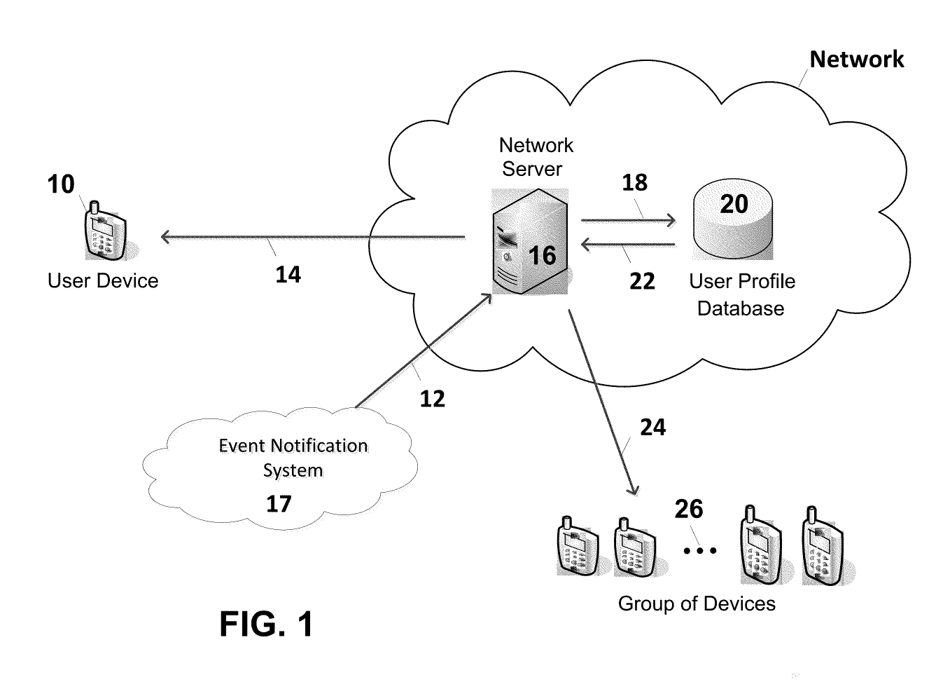

FIG. 1 is a diagram of an example system and process for providing a location of a device to members of group associated with the device. When an event such as earthquake, flood, hurricane, or tornado occurs, the event notification system 17 may notify the network server 16 an indication of the event at step 12. The event notification system may comprise any appropriate system, device, service, service, or the like. In various example embodiments, the event notification system 17 may comprise the Federal Emergency Management Agency (FEMA), National Weather Service (NWS), the National Oceanic and Atmospheric Administration (NOAA), Department of Homeland Security, social media, any appropriate system configured to provide a notification of event, or any appropriate combination thereof.

Upon receiving the indication of the event (at step 12), the network server 16 may determine the region of the event and trigger an event alert request to the user profile database 20 at step 18. For example, in case of the emergency event, the network server 16 may receive information about disaster area from FEMA and determine the region of the event. The event alert request may include information about type of event, region, time, or level of severity.

Upon receiving the event alter request (at step 18), the user profile database 20 may update its content, the user profiles. For example, the user profile database 20 may update users' personal information, location information, and subscription information. Upon updating the user profiles, the user profile database 20 may transmit the updated user profile data to the network server 16 at step 22.

Upon receiving the updated user profile data (at step 22), the network server 16 may determine whether the location of user device 10 is within the region of the event. The location of the user device 10 may be stored in the user profile data. The network server 16 may compare the region of the event to the location of the user device 10. If the location of the user device 10 is within the region of the event, the network server 16 may proceed to determine group of devices 26 to be notified. To determine the group of devices 26 associated with the user device 10, the event alert server 16 may analyze the user's personal information, location information, and subscription information stored on the updated user profile data. If the user device 10 is not within the region, the network server 16 may not proceed to determine group of devices 26.

Upon determining the group of devices 26, the network server 16 may transmit the location information of the user device 10 to the group of devices 26 at step 24. The group of devices 26 may include family, relatives, friends, or colleagues to the user device 10. The group of devices 26 may also include police officers, firefighters, and emergency rescue team who are geographically proximate to the user device 10. At step 14, the network server 16 may also transmit information about the group of devices 26 to the user device 10 to notify available people or helpful information around the user device 10.

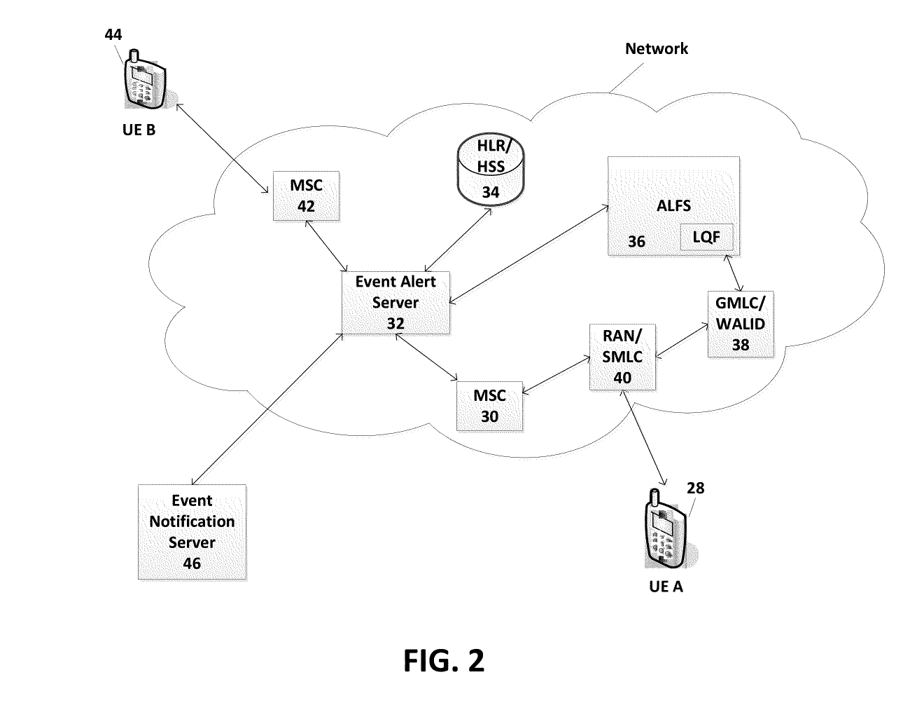

FIG. 2 is a diagram of an example system and process for providing a location of a device to an entity associated with the device in a cellular network. In an example embodiment, the event alert server 32 may periodically update the current location of the UE A 28 and receive the location information of UE A 28. The location information of the UE A 28 may be stored in HLR/HSS 34. When an event such as earthquake occurs, the event alert server 32 may receive an indication of the event from event notification server 46. The functions of the event alert server 32 may locate in Home Location Register (HLR), Home Subscriber Server (HSS), or Automatic Location Function Server (ALFS). The functions of the event notification server 46 may locate in FEMA, NWS, or any system configured to notify a certain event.

Upon receiving the indication of the event, the event alert server 32 may determine the region of the event and trigger an event alert request to HLR/HSS 34 where the user profile data are stored. Upon receiving the event alert request, the HLR/HSS 34 may update the user profiles of uses whose devices are located in the region of the event. Then, the HLR/HSS 34 may transmit the updated user profile data to the event alert server 32. The updated user profile data may contain information about users, location of devices, and subscription of the users.

Upon receiving the updated user profile data, the event alert server 32 may determine whether the location of the UE A 28 is within the region of the event. The location of the UE A 28 may be stored in the user profile data. If the location of the UE A 28 is within the region of the event, the event alert server 32 may proceed to determine other devices that needs to be notified the location of the UE A 28. Assuming the user profile data includes personal information of the UE A 28 that the UE B 44 is an emergency contact to the UE A 28, the event alert server 32 may determine the UE B 44 associated with the UE A 28.

Upon determining the UE B 44 as the device associated with the UE A 28, the event alert server 32 may update the current location of the UE A 28 to provide the latest location of the UE A 28 to the UE B 44. For example, the event alert server 32 may transmit the location update request to the Auto Location Function Server (ALFS) 36. Once the location request is received at the ALFS 36, the ALFS 36 may trigger Location Query function (LQF). The LQF may send a new location update request for the UE A 28 to the Gateway Mobile Location Center/WALID (GMLC/WALID) 38 and the RAN/SMLC 40. The GMLC/WALID 38 may include subscriber location database and the RAN/SMLC 40 may maintain subscriber location history.

Upon receiving the new location update request, the UE A 28 may execute location update and report its latest location to the GMLC/WALID 38, the RAN/SMLC 40 and the ALFS 36. Once the ALFS 36 receives the latest location of the UE A 28, the ALFS 36 may transmit the latest location of the UE A 28 to the event alert server 32. The event alert server 32 may provide the latest location information of the UE A 28 to the UE B 44 via MSC 42.

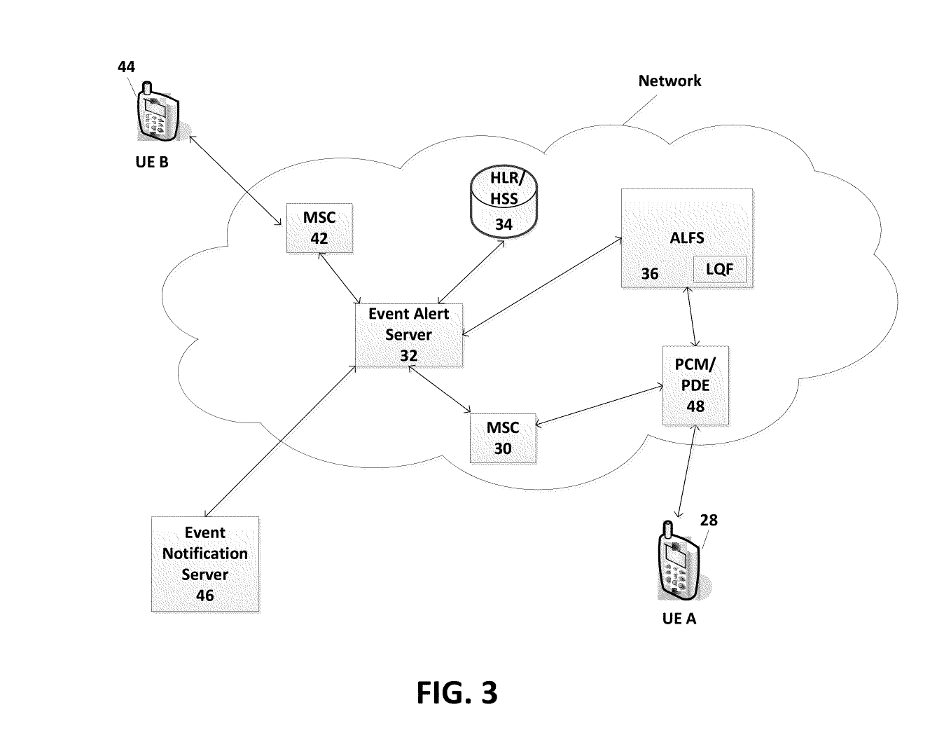

FIG. 3 is another diagram of an example system and process for providing a location of a device to an entity associated with the device in a cellular network. As described above in FIG. 2, the event alert server 32 may perform the same process until the event alert server 32 transmits the location update request to the Auto Location Function Server (ALFS) 36. Once the location request is received at the ALFS 36, the ALFS 36 may trigger Location Query function (LQF). The LQF may transmit the new location update request for the UE A 28 to the PCM/PDE 48. The PCM/PDE 49 may have functions of managing and/or maintaining subscriber location database and location history.

Upon receiving the new location update request, the UE A 28 may execute location update and report its latest location to the PCM/PDE 48 and the ALFS 36. Once the ALFS 36 receives the latest location of the UE A 28, the ALFS 36 may transmit the latest location of the UE A 28 to the event alert server 32. The event alert server 32 may provide the latest location information of the UE A 28 to the UE B 44 via MSC 42.

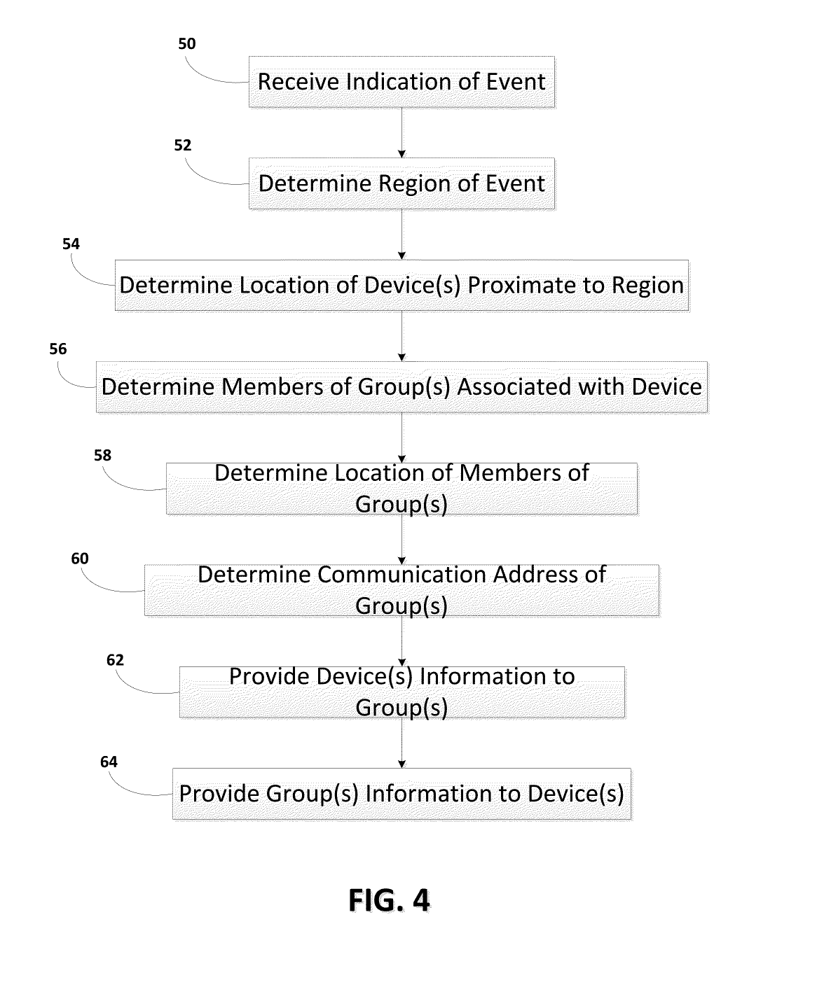

FIG. 4 is a flow diagram of an example process for providing a location of a device to members of group(s) associated with the device. In an example embodiment, when an event such as earthquake occurs, a network server may receive an indication of the event from event notification systems at step 50. The type of event may comprise an emergency event, a personal event, or the like. The emergency event may include chemical emergency, drought, earthquake, flood, heat wave, hurricane, landslide, power outage, terrorism, thunderstorm, tornado, tsunami, volcano, wildfire, or winter storm. The personal event may include a user defined event. For example, parents may set or define a boundary of region within which their child must stay. If the device of the child strays out of the boundary, the network server may trigger a personal event to notify the location of the child's device.

Upon receiving the indication of the event (at step 50), the network server may determine a region of the event at step 52. For example, the network server may recognize the region of the event by receiving disaster area information from the event notification systems. The disaster area may be determined or declared by the event notification systems such as FEMA. For example, FEMA may declare the area of DC, DE, MD, PA, VA, and WV as the Region III and notify it to the network server via electronic data format. In case of the personal event, the network server may determine outside of the boundary as the region of event triggering the indication of the event by the event notification system. In a cellular network, the region of the event can be a cell, a combination of multiple cells, a MSC, a combination of multiple MSC, or the like.

Upon determining the region of the event (at step 52), the network server may determine whether the location of the device is geographically proximate to the region of the event at step 54. The location of the device may be stored in the user profile database. For example, the network server may determine that the location of the device is geographically proximate to the region of the event if the location of the device is within the region of the event.

Upon determining that the location of the device is geographically proximate to the region (at step 54), the network server may determine members of group associated with the device at step 56. For example, the network server may analyze the user's personal information to determine the members of group. The network server may retrieve the user's phone book information stored on the user profile database to find family members associated with the device. Moreover, the network server may analyze location information of other users in the region to find person who is geographically proximate to the location of the user. The network server may also analyze subscription information such as call history or billing history to determine the members of group. The network server may also use any combination of the personal information, the location information, and the subscription information to determine the members of group.

Upon determining the members of group associated with the device (at step 56), the network server may determine the locations of the group at step 58. The locations of the group may be stored on the user profile database or other location management database. The network server may also initiate a new location update for the group to determine the latest locations of the members in the group. Upon determining the locations of the group (at step 58), the network server may determine communication address of the group at step 60. In an example embodiment, the communication address may be a format of receiving information about the device. The format may include an email, a voice message, SMS, MMS, text messaging, a link to Google map, a HTTP text, an address, or GPS coordinates. The format of the information may be tailored depending on types of device.

Upon determining the communication address of the group (at step 60), the network server may provide information about the device to the members of group at step 62. In an example embodiment, the information about the device may include the location of the device. This location of the device may be helpful for the members of the group who are looking for the location of the user, especially in urgent situation. This location is also helpful for the rescue team associated with the device to find the location of the user in an emergency situation. In various embodiments, the information about the device may include the type of event, current state of the event, time of the event, severity of the event, or instructions under the event. In case of emergency event, the instructions may include emergency treatment procedures such as Cardiopulmonary resuscitation (CPR) or First aid.

The information about the device may also include latest time that the device reported its location, information about nearby emergency assistance such as the police, fire service, hospital, emergency medical service, or rescue teams. The information may also include direction to nearby shelters or phone numbers of nearby rescue team. In another example embodiment, the network server may periodically provide the information about the device to the members of group. For example, the network server may transmit the information once every half hour or once every hour until the event ends.

Upon providing the device information to the members of group (at step 60), the network server may provide information about the group to the device at step 64. For example, the information about the group may include the locations of the group. These locations of the group may be useful for a user who needs to find other people associated with the user. In an example embodiment, the information about the group may include the type of event, current state of the event, time of the event, severity of the event, or instructions under the event. The information about the group may also include information about nearby emergency assistance such as the police, fire service, hospitals, emergency medical service, or rescue teams. The information may also include direction to nearby shelters or phone numbers of nearby rescue team. In another example embodiment, the network server may periodically provide the information about the group to the device. For example, the network server may transmit the information once every fifteen minutes or once every half hour until the user of the device responds the notification.

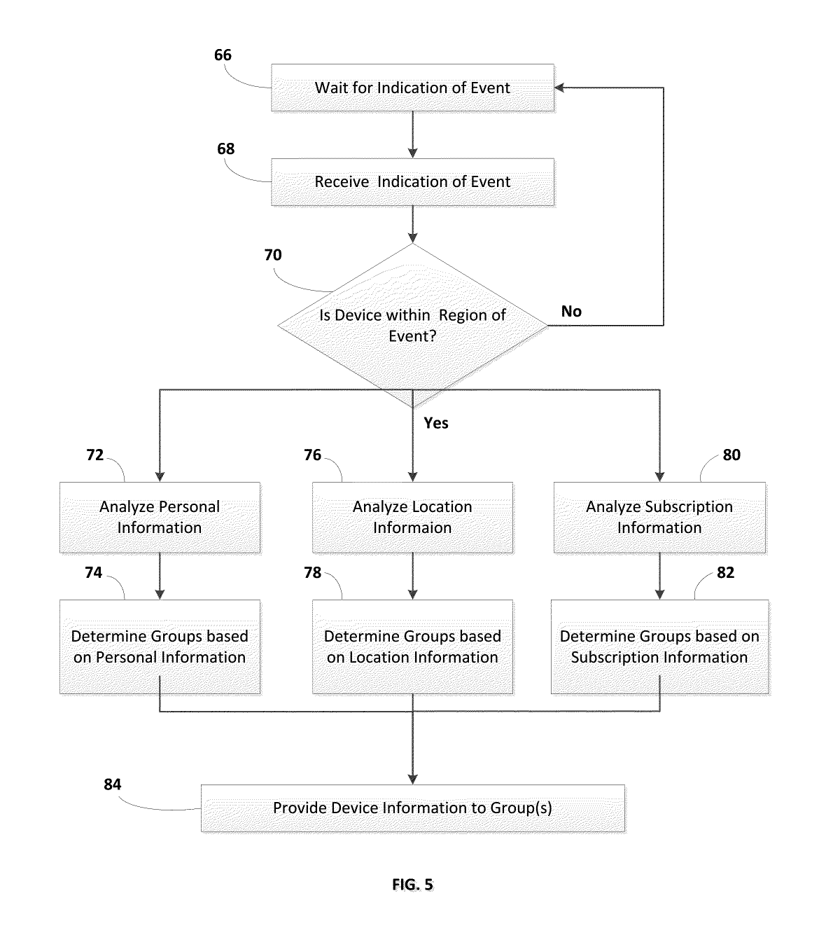

FIG. 5 is a flow diagram of an example process for determining members of group(s) associated with a device. In an example embodiment, a network server may wait for an indication of an event at step 66. Upon receiving the indication of the event at step 68, the network server may determine whether the device is within the region of the event at step 70. If the device is not within the region of the event, the network server may not further proceed and wait for another indication of event at step 66. If the device is within the region of the event, the network server may proceed to determine the members of group associated with the device.

In an example embodiment, the network server may choose one of three methods to determine the members of the group associated with the device as described at steps 72, 76, and 80. First, the network server may analyze personal information of user profile data at step 72 and determine the group based on the personal information at step 74. The personal information may include information about the users such as names, addresses, occupations, phone numbers, emergency contact numbers, or phone book information. For example, the network server may retrieve emergency contact list on the user profile data associated with the device, and then the network server may determine the members of the group based on the emergency contact list.

In another example embodiment, the network server may retrieve occupation information about users stored on the user profile database. The network server may add a person into the members of the group based on the occupation information if the person's occupation is a medical doctor, a nurse, or an emergency medic and the person is geometrically proximate to the location of the user device. In another example embodiment, the network server may use address information stored on the user profile database. For example, if a person's address is the same with the user whose location is sought and the person is geometrically proximate to the location of the user device, the network server may add the person as a family member or a roommate into the members of the group to be notified.

The network server may analyze location information of users stored in the user profile database at step 76 and determine the group based on the location information at step 78. The location information of users may include current locations, a user defined locations, location history, the region of the event, time of the region, or time of the event. For example, the network server may search the locations of other devices in the region, and determine the other devices geometrically proximate to the location of the device as the members of the group.

The network server may analyze subscription information of users at step 80 and determine the group based on the subscription information at step 82. The subscription information of users may include call history, billing history, or SMS/MMS history. For example, the network server may review the call history of the device and determine the parties who recently contacted with the user as the members of the group to be notified.

In various example embodiments, the network server may choose any combination of the aforementioned techniques to determine members of group at step 72, 76, and 80. For example, the event server may combine personal information at step 72, location information at 76 and subscription information at step 80 to determine the members of the group. The event server may combine the personal information and the location information, the personal information and the subscription information, or the location information and the subscription information. For example, if a person pays the bill of the device of the user and the person and the user have similar pattern of the location history, the network server may determine the person is to be included into the members of the group to be notified.

Upon determining the members of group associated with the device at steps 74, 78, and 82, as described above FIG. 4, the network server may provide information about the device to the members of group at step 84.

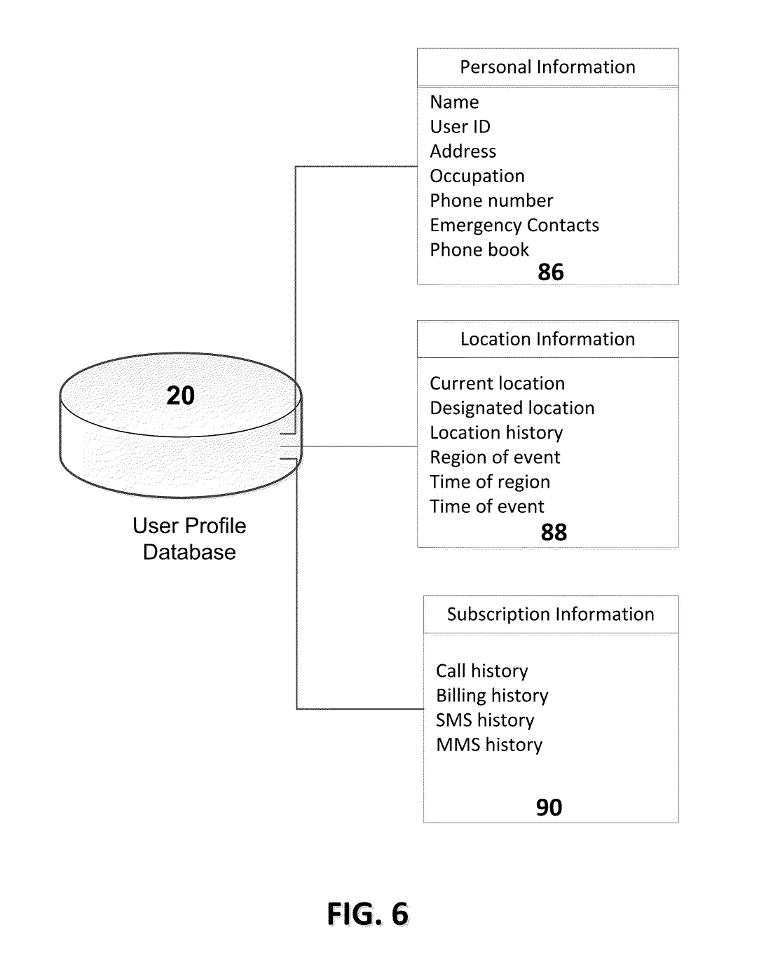

FIG. 6 is a block diagram of an example user profile database 20. In an example embodiment, the user profile database 20 may include personal information 86, location information 88, and subscription information 90. The personal information 86 may include users' names, user IDs, addresses, occupations, phone numbers, emergency contacts, and phone books. The location information 88 may include current location of each user, user designated location, users' location history, region of the event, time of the region, and time of the event. The subscription information 90 may include each user's call history, billing history, and SMS/MMS history.

In an example embodiment, a user may edit his or her user profile data. For example, the user may change his or her address, occupation, or phone numbers and emergency contact numbers. The user may update his or her designated location to trigger the personal event notification. The network server may also update the user profile database 20. For example, as the region of the event such as a storm moves, the network server may update the region of the event, the time of the region, and the time of the event. The network server may be configured to periodically receive the updated event notification from the event notification system.

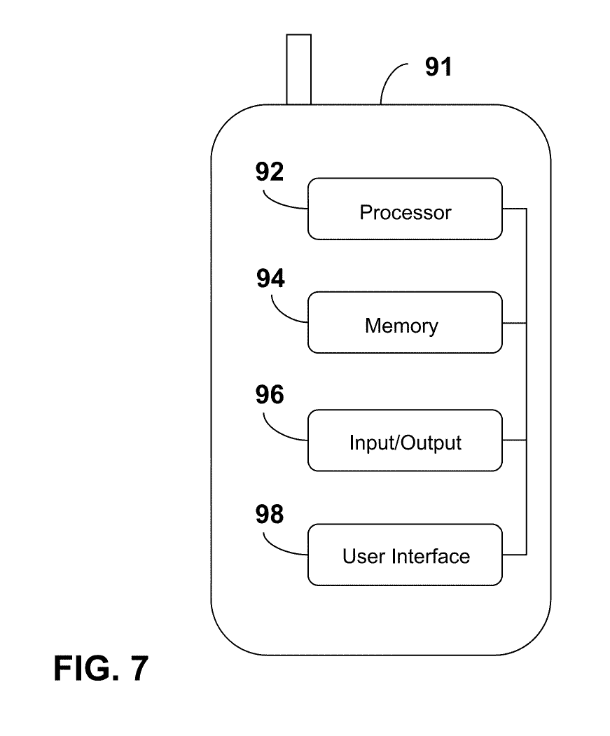

FIG. 7 is a block diagram of an example device 91 that may be utilized to facilitate an event based location-based service as described herein. The device 91 may comprise and/or be incorporated into any appropriate device, examples of which may include user device 10, devices 26, UE A 28, UE B 44, a mobile device, a mobile communications device, a cellular phone, a portable computing device, such as a laptop, a personal digital assistant (“PDA”), a portable phone (e.g., a cell phone or the like, a smart phone, a video phone), a portable email device, a portable gaming device, a TV, a DVD player, portable media player, (e.g., a portable music player, such as an MP3 player, a Walkman, etc.), a portable navigation device (e.g., GPS compatible device, A-GPS compatible device, etc.), or a combination thereof. The device 91 can include devices that are not typically thought of as portable, such as, for example, a public computing device, a navigation device installed in-vehicle, a set top box, or the like. The mobile device 91 can include non-conventional computing devices, such as, for example, a kitchen appliance, a motor vehicle control (e.g., steering wheel), etc., or the like, or any appropriate combination thereof. As evident from the herein description a communications device, a mobile device, or any portion thereof is not to be construed as software per se.

The device 91 may include any appropriate device, mechanism, software, and/or hardware for facilitating and/or implementing an event based location-based service as described herein. In an example embodiment, implementation of an event based location-based service is a feature of the device 91 that may be turned on and off Thus, in an example embodiment, an owner and/or user of the device 91 may opt-in or opt-out of this capability.

In an example embodiment, the device 91 may comprise a processor and memory coupled to the processor. The memory may comprise executable instructions that when executed by the processor cause the processor to effectuate operations associated with an event based location-based service as described herein.

In an example configuration, the device 91 comprises a processor 92, a memory 94, an input/output 96, and a user interface (UI) 98. Each portion of the device 91 comprises circuitry for performing functions associated with each respective portion. Thus, each portion can comprise hardware, or a combination of hardware and software. Accordingly, each portion of the device 91 is not to be construed as software per se. It is emphasized that the block diagram depiction of device 91 is exemplary and not intended to imply a specific implementation and/or configuration. For example, in an example configuration, the device 91 may comprise a cellular communications technology and the processor 92 and/or the memory 94 may be implemented, in part or in total, on a subscriber identity module (SIM) of the device 91. In another example configuration, the device 91 may comprise a laptop computer. The laptop computer may include a SIM, and various portions of the processor 92 and/or the memory 94 may be implemented on the SIM, on the laptop other than the SIM, or any combination thereof.

The processor 92, memory 94, and input/output 96 may be coupled together to allow communications therebetween. In various embodiments, the input/output 96 may comprise a receiver of the device 91, a transmitter of the device 91, or a combination thereof. The input/output 96 may be capable of receiving and/or providing information pertaining to an event based location-based service as described herein In various configurations, the input/output 96 may receive and/or provide information via any appropriate means, such as, for example, optical means (e.g., infrared), electromagnetic means (e.g., RF, WI-FI, BLUETOOTH, ZIGBEE, etc.), acoustic means (e.g., speaker, microphone, ultrasonic receiver, ultrasonic transmitter), or a combination thereof.

The processor 92 may be capable of performing functions pertaining to an event based location-based service as described herein. In a basic configuration, the device 91 may include at least one memory 94. The memory 94 may comprise a storage medium having a concrete, tangible, physical structure. Thus, the memory 94, as well as any computer-readable storage medium described herein, is not to be construed as a transient signal per se. Further, the memory 94, as well as any computer-readable storage medium described herein, is not to be construed as a propagating signal per se. The memory 94, as well as any computer-readable storage medium described herein, is to be construed as an article of manufacture. The memory 94 may store any information utilized in conjunction with an event based location-based service as described herein. Depending upon the exact configuration and type of processor, the memory 94 may be volatile (such as some types of RAM), non-volatile (such as ROM, flash memory, etc.), or a combination thereof. The mobile device 91 may include additional storage (e.g., removable storage and/or non-removable storage) including, but not limited to, tape, flash memory, smart cards, CD-ROM, digital versatile disks (DVD) or other optical storage, magnetic cassettes, magnetic tape, magnetic disk storage or other magnetic storage devices, universal serial bus (USB) compatible memory, or any other medium which can be used to store information and which can be accessed by the mobile device 91.

The device 91 also may contain a user interface (UI) 98 allowing a user to communicate with the device 91. The UI 98 may be capable of rendering any information utilized in conjunction with an event based location-based service as described herein. The UI 98 may provide the ability to control the device 91, via, for example, buttons, soft keys, voice actuated controls, a touch screen, movement of the mobile device 91, visual cues (e.g., moving a hand in front of a camera on the mobile device 91), or the like. The UI 98 may provide visual information (e.g., via a display), audio information (e.g., via speaker), mechanically (e.g., via a vibrating mechanism), or a combination thereof. In various configurations, the UI 98 may comprise a display, a touch screen, a keyboard, an accelerometer, a motion detector, a speaker, a microphone, a camera, a tilt sensor, or any combination thereof. The UI 98 may comprise means for inputting biometric information, such as, for example, fingerprint information, retinal information, voice information, and/or facial characteristic information.

The UI 98 may include a display for displaying multimedia such as, for example, application graphical user interfaces (GUIs), text, images, video, telephony functions such as Caller ID data, setup functions, menus, music, metadata, messages, wallpaper, graphics, Internet content, device status, preferences settings, map and location data, routes and other directions, points of interest (POI), and the like.

In some embodiments, the UI portion may comprise a user interface (UI) application. The UI application may interface with a client or operating system (OS) to, for example, facilitate user interaction with device functionality and data. The UI application may aid a user in entering message content, viewing received messages, answering/initiating calls, entering/deleting data, entering and setting user IDs and passwords, configuring settings, manipulating content and/or settings, interacting with other applications, or the like, and may aid the user in inputting selections associated with an event based location-based service as described herein.

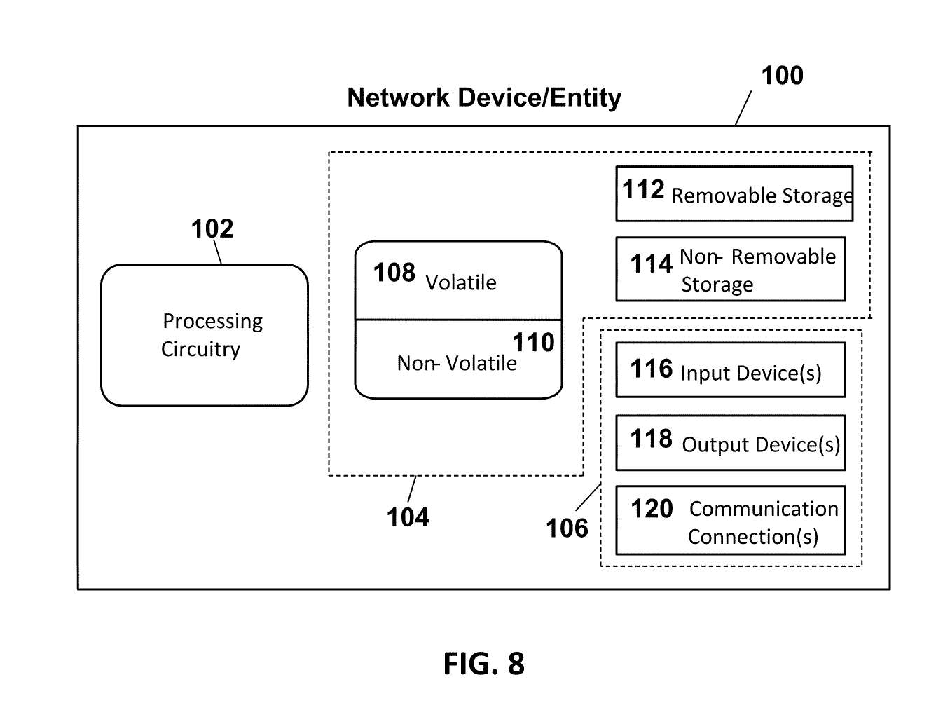

FIG. 8 is a block diagram of an example network device (entity) 100 that may be utilized to implement and/or facilitate event based location-based service as described herein. The device 100 may comprise hardware or a combination of hardware and software. In an example embodiment, the device 100 may comprise a network entity and when used in conjunction with a network, the functionality needed to facilitate an event based location-based service as described herein nay reside in any one or combination of devices. The device 100 depicted in FIG. 8 may represent any appropriate network entity, or combination of network entities, such as, for example, network server 16, event alert server 32, MSC 30, ALFS 36, MSC 42, event notification server 46, a processor, a server, a gateway, a node, or any appropriate combination thereof. In an example configuration, the device 100 may comprise a component or various components of a cellular broadcast system wireless network. It is emphasized that the block diagram depicted in FIG. 8 is exemplary and not intended to imply a specific implementation or configuration. Thus, the device 100 may be implemented in a single processor or multiple processors (e.g., single server or multiple servers, single gateway or multiple gateways, etc.). Multiple network entities may be distributed or centrally located. Multiple network entities may communicate wirelessly, via hard wire, or any appropriate combination thereof.

In an example embodiment, the device 100 may comprise a processor and memory coupled to the processor. The memory may comprise executable instructions that when executed by the processor cause the processor to effectuate operations associated with an event based location-based service as described herein. As evident from the herein description device 100 is not to be construed as software per se.

In an example configuration, device 100 may comprise a processor 102, a memory 104, and an input/output 106. The processor 102, memory 104, and input/output 106 may be coupled together (coupling not shown in FIG. 8) to allow communications therebetween. Each portion of the device 100 comprises circuitry for performing functions associated with each respective portion. Thus, each portion may comprise hardware, or a combination of hardware and software. Accordingly, each portion of the device 100 is not to be construed as software per se. The input/output 106 may be capable of receiving and/or providing information from/to a communications device and/or other network entities configured for an event based location-based service as described herein. For example, the input/output 106 may include a wireless communications (e.g., 2.5G/3G/4G/GPS) card. The input/output 106 may be capable of receiving and/or sending video information, audio information, control information, image information, data, or any combination thereof. In an example embodiment, the input/output 106 may be capable of receiving and/or sending information to determine a location of the device 100 and/or the communications device 100. In an example configuration, the input\output portion 96 may comprise a GPS receiver. In an example configuration, the device 100 may determine its own geographical location and/or the geographical location of a communications device through any type of location determination system including, for example, the Global Positioning System (GPS), assisted GPS (A-GPS), time difference of arrival calculations, configured constant location (in the case of non-moving devices), any combination thereof, or any other appropriate means. In various configurations, the input/output 106 may receive and/or provide information via any appropriate means, such as, for example, optical means (e.g., infrared), electromagnetic means (e.g., RF, WI-FI, BLUETOOTH, ZIGBEE, etc.), acoustic means (e.g., speaker, microphone, ultrasonic receiver, ultrasonic transmitter), or a combination thereof. In an example configuration, the input/output portion may comprise a WIFI finder, a two way GPS chipset or equivalent, or the like, or a combination thereof.

The processor 102 may be capable of performing functions associated with an event based location-based service as described herein. For example, the processor 102 may be capable of, in conjunction with any other portion of the device 100, installing an application for an event based location-based service as described herein.

In a basic configuration, the device 100 may include at least one memory 104. The memory 104 may comprise a storage medium having a concrete, tangible, physical structure. Thus, the memory 104, as well as any computer-readable storage medium described herein, is not to be construed as a transient signal per se. The memory 104, as well as any computer-readable storage medium described herein, is not to be construed as a propagating signal per se. The memory 104, as well as any computer-readable storage medium described herein, is to be construed as an article of manufacture. The memory 104 may store any information utilized in conjunction with an event based location-based service as described herein. Depending upon the exact configuration and type of processor, the memory 104 may be volatile 108 (such as some types of RAM), non-volatile 110 (such as ROM, flash memory, etc.), or a combination thereof. The device 100 may include additional storage (e.g., removable storage 112 and/or non-removable storage 114) including, for example, tape, flash memory, smart cards, CD-ROM, digital versatile disks (DVD) or other optical storage, magnetic cassettes, magnetic tape, magnetic disk storage or other magnetic storage devices, universal serial bus (USB) compatible memory, or any other medium which can be used to store information and which can be accessed by the device 100.

The device 100 also may contain communications connection(s) 110 that allow the device 100 to communicate with other devices, network entities, or the like. A communications connection(s) may comprise communication media. Communication media typically embody computer readable instructions, data structures, program modules or other data in a modulated data signal such as a carrier wave or other transport mechanism and includes any information delivery media. By way of example, and not limitation, communication media may include wired media such as a wired network or direct-wired connection, and wireless media such as acoustic, RF, infrared, and other wireless media. The term computer readable media as used herein includes both storage media and communication media. The device 100 also may include input device(s) 116 such as keyboard, mouse, pen, voice input device, touch input device, etc. Output device(s) 118 such as a display, speakers, printer, etc. also may be included.

An event based location-based service as described herein may be part of and/or communicate with various wireless communications networks. Some of which are described below.

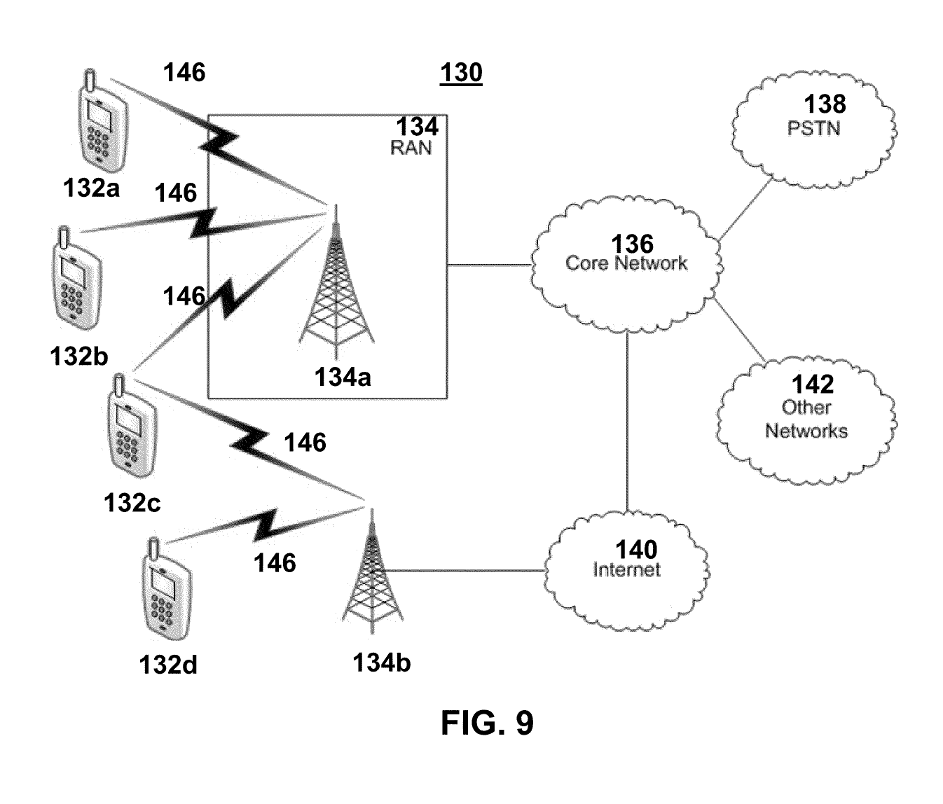

FIG. 9 is a diagram of an example communications system in which an event based location-based service as described herein may be implemented. The communications system 130 may be a multiple access system that provides content, such as voice, data, video, messaging, broadcast, etc., to multiple wireless users. The communications system 130 may enable multiple wireless users to access such content through the sharing of system resources, including wireless bandwidth. For example, the communications systems 130 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like. A communications system such as that shown in FIG. 9 may also be referred to herein as a network.

As shown in FIG. 9, the communications system 130 may include wireless transmit/receive units (WTRUs) 132a, 132b, 132c, 132d, a radio access network (RAN) 134, a core network 136, a public switched telephone network (PSTN) 108, the Internet 140, and other networks 142, though it will be appreciated that the disclosed embodiments contemplate any number of WTRUs, base stations, networks, and/or network elements. Each of the WTRUs 132a, 132b, 132c, 132d may be any type of device configured to operate and/or communicate in a wireless environment. For example, a WTRU may comprise user device 10, device 26, network server 16, event notification system 17, UE A 28, MSC 30, event alert server 32, ALFS 36, MSC 42, UE B 44, event notification server 46, or any appropriate combination thereof. By way of example, the WTRUs 132a, 132b, 132c, 132d may be configured to transmit and/or receive wireless signals and may include user equipment (UE), a mobile station, a mobile device, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 134a and a base station 134b. Each of the base stations 134a, 134b may be any type of device configured to wirelessly interface with at least one of the WTRUs 132a, 132b, 132c, 132d to facilitate access to one or more communication networks, such as the core network 136, the Internet 140, and/or the networks 142. By way of example, the base stations 134a, 134b may be a base transceiver station (BTS), a Node-B, an eNode B, a Home Node B, a Home eNode B, a site controller, an access point (AP), a wireless router, and the like. While the base stations 134a, 134b are each depicted as a single element, it will be appreciated that the base stations 134a, 134b may include any number of base station 134a may be part of the Radio Access Network (RAN) 134, which may also include interconnected base stations and/or network elements.

The other base stations and/or network elements (not shown), such as a base station controller (BSC), a radio network controller (RNC), relay nodes, etc. The base station 134a and/or the base station 134b may be configured to transmit and/or receive wireless signals within a particular geographic region, which may be referred to as a cell (not shown). The cell may further be divided into cell sectors. For example, the cell associated with the base station 134a may be divided into three sectors. Thus, in an embodiment, the base station 134a may include three transceivers, i.e., one for each sector of the cell. In another embodiment, the base station 134a may employ multiple-input multiple output (MIMO) technology and, therefore, may utilize multiple transceivers for each sector of the cell.

The base stations 134a, 134b may communicate with one or more of the WTRUs 132a, 132b, 132c, 132d over an air interface 146, which may be any suitable wireless communication link (e.g., radio frequency (RF), microwave, infrared (IR), ultraviolet (UV), visible light, etc.). The air interface 146 may be established using any suitable radio access technology (RAT).

More specifically, as noted above, the communications system 130 may be a multiple access system and may employ one or more channel access schemes, such as CDMA, TDMA, FDMA, OFDMA, SC-FDMA, and the like. For example, the base station 134a in the RAN 134 and the WTRUs 132a, 132b, 132c may implement a radio technology such as Universal Mobile Telecommunications System (UMTS) Terrestrial Radio Access (UTRA) that may establish the air interface 146 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 134a and the WTRUs 132a, 132b, 132c may implement a radio technology such as Evolved UMTS Terrestrial Radio Access (E-UTRA), which may establish the air interface 146 using Long Term Evolution (LTE) and/or LTE-Advanced (LTE-A).

In other embodiments, the base station 134a and the WTRUs 132a, 132b, 132c may implement radio technologies such as IEEE 802.16 (i.e., Worldwide Interoperability for Microwave Access (WiMAX)), CDMA2000, CDMA2000 1x, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 134a\b in FIG. 9 may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 134a\b and the WTRUs 132c, 132d may implement a radio technology such as IEEE 802.11 to establish a wireless local area network (WLAN). In another embodiment, the base station 134a\b and the WTRUs 132c, 132d may implement a radio technology such as IEEE 802.15 to establish a wireless personal area network (WPAN). In yet another embodiment, the base station 134a\b and the WTRUs 132c, 132d may utilize a cellular-based RAT (e.g., WCDMA, CDMA2000, GSM, LTE, LTE-A, etc.) to establish a picocell or femtocell. As shown in FIG. 9, the base station 134a\b may have a direct connection to the Internet 140. Thus, the base station 134a\b may not be required to access the Internet 140 via the core network 136.

The RAN 134 may be in communication with the core network 136, which may be any type of network configured to provide voice, data, applications, and/or voice over internet protocol (VoIP) services to one or more of the WTRUs 132a, 132b, 132c, 132d. For example, the core network 136 may provide call control, billing services, mobile location-based services, pre-paid calling, Internet connectivity, video distribution, etc., and/or perform high-level security functions, such as user authentication. Although not shown in FIG. 9, it will be appreciated that the RAN 134 and/or the core network 136 may be in direct or indirect communication with other RANs that employ the same RAT as the RAN 134 or a different RAT. For example, in addition to being connected to the RAN 134, which may be utilizing an E-UTRA radio technology, the core network 136 may also be in communication with another RAN (not shown) employing a GSM radio technology.

The core network 136 may also serve as a gateway for the WTRUs 132a, 132b, 132c, 132d to access the PSTN 138, the Internet 140, and/or other networks 142. The PSTN 138 may include circuit-switched telephone networks that provide plain old telephone service (POTS). The Internet 140 may include a global system of interconnected computer networks and devices that use common communication protocols, such as the transmission control protocol (TCP), user datagram protocol (UDP) and the internet protocol (IP) in the TCP/IP internet protocol suite. The networks 142 may include wired or wireless communications networks owned and/or operated by other service providers. For example, the networks 142 may include another core network connected to one or more RANs, which may employ the same RAT as the RAN 134 or a different RAT.

Some or all of the WTRUs 132a, 132b, 132c, 132d in the communications system 130 may include multi-mode capabilities, i.e., the WTRUs 132a, 132b, 132c, 132d may include multiple transceivers for communicating with different wireless networks over different wireless links. For example, the WTRU 132c shown in FIG. 9 may be configured to communicate with the base station 134a, which may employ a cellular-based radio technology, and with the base station 134a\b, which may employ an IEEE 802 radio technology.

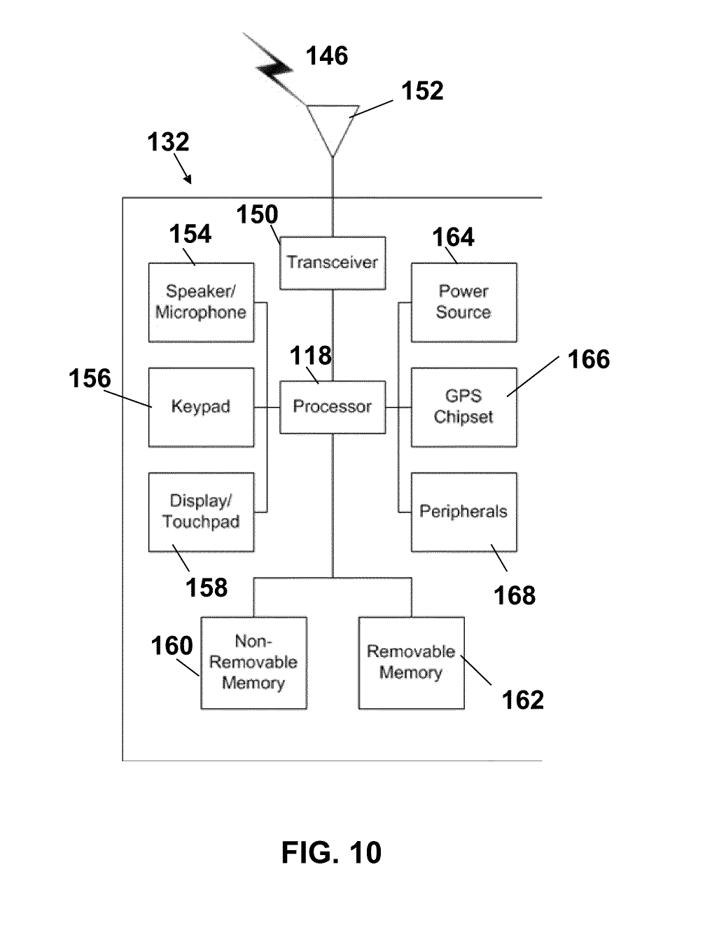

FIG. 10 is a system diagram of an example WTRU 132. As shown in FIG. 10, the WTRU 132 may include a processor 118, a transceiver 150, a transmit/receive element 152, a speaker/microphone 154, a keypad 156, a display/touchpad 158, non-removable memory 160, removable memory 162, a power source 164, a global positioning system (GPS) chipset 166, and other peripherals 168. It will be appreciated that the WTRU 132 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 132 to operate in a wireless environment. The processor 118 may be coupled to the transceiver 150, which may be coupled to the transmit/receive element 152. While FIG. 10 depicts the processor 118 and the transceiver 150 as separate components, it will be appreciated that the processor 118 and the transceiver 150 may be integrated together in an electronic package or chip.

The transmit/receive element 152 may be configured to transmit signals to, or receive signals from, a base station (e.g., the base station 114a) over the air interface 116. For example, in one embodiment, the transmit/receive element 152 may be an antenna configured to transmit and/or receive RF signals. In another embodiment, the transmit/receive element 152 may be an emitter/detector configured to transmit and/or receive IR, UV, or visible light signals, for example. In yet another embodiment, the transmit/receive element 152 may be configured to transmit and receive both RF and light signals. It will be appreciated that the transmit/receive element 152 may be configured to transmit and/or receive any combination of wireless signals.

In addition, although the transmit/receive element 152 is depicted in FIG. 10 as a single element, the WTRU 132 may include any number of transmit/receive elements 152. More specifically, the WTRU 132 may employ MIMO technology. Thus, in one embodiment, the WTRU 132 may include two or more transmit/receive elements 152 (e.g., multiple antennas) for transmitting and receiving wireless signals over the air interface 146.

The transceiver 150 may be configured to modulate the signals that are to be transmitted by the transmit/receive element 152 and to demodulate the signals that are received by the transmit/receive element 152. As noted above, the WTRU 132 may have multi-mode capabilities. Thus, the transceiver 150 may include multiple transceivers for enabling the WTRU 132 to communicate via multiple RATs, such as UTRA and IEEE 802.11, for example.

The processor 118 of the WTRU 132 may be coupled to, and may receive user input data from, the speaker/microphone 154, the keypad 156, and/or the display/touchpad 158 (e.g., a liquid crystal display (LCD) display unit or organic light-emitting diode (OLED) display unit). The processor 118 may also output user data to the speaker/microphone 154, the keypad 156, and/or the display/touchpad 158. In addition, the processor 118 may access information from, and store data in, any type of suitable memory, such as the non-removable memory 160 and/or the removable memory 162. The non-removable memory 160 may include random-access memory (RAM), read-only memory (ROM), a hard disk, or any other type of memory storage device. The removable memory 162 may include a subscriber identity module (SIM) card, a memory stick, a secure digital (SD) memory card, and the like. In other embodiments, the processor 118 may access information from, and store data in, memory that is not physically located on the WTRU 132, such as on a server or a home computer (not shown).

The processor 118 may receive power from the power source 164, and may be configured to distribute and/or control the power to the other components in the WTRU 132. The power source 164 may be any suitable device for powering the WTRU 132. For example, the power source 164 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 166, which may be configured to provide location information (e.g., longitude and latitude) regarding the current location of the WTRU 132. In addition to, or in lieu of, the information from the GPS chipset 166, the WTRU 132 may receive location information over the air interface 146 from a base station (e.g., base stations 134a, 134b) and/or determine its location based on the timing of the signals being received from two or more nearby base stations. It will be appreciated that the WTRU 132 may acquire location information by way of any suitable location-determination method while remaining consistent with an embodiment.

The processor 118 may further be coupled to other peripherals 168, which may include one or more software and/or hardware modules that provide additional features, functionality and/or wired or wireless connectivity. For example, the peripherals 168 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

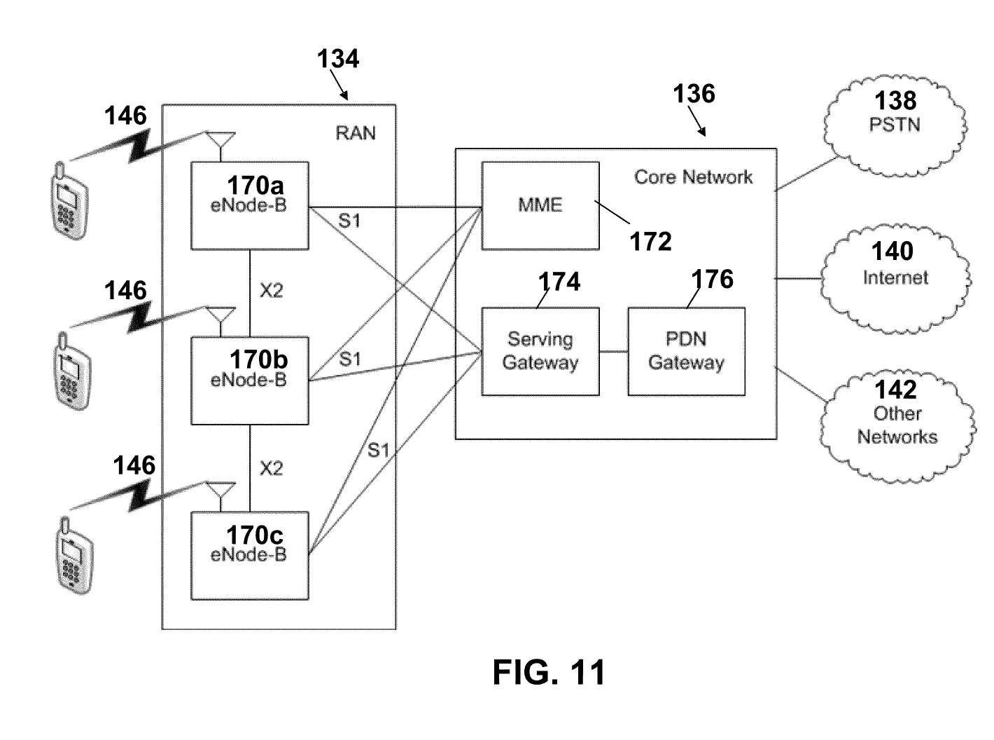

FIG. 11 is an example system diagram of RAN 134 and a core network 136. As noted above, the RAN 134 may employ an E-UTRA radio technology to communicate with the WTRUs 132a, 132b, and 132c over the air interface 146. The RAN 134 may also be in communication with the core network 136.

The RAN 134 may include eNode-Bs 170a, 170b, 170c, though it will be appreciated that the RAN 134 may include any number of eNode-Bs while remaining consistent with an embodiment. The eNode-Bs 170a, 170b, 170c may each include one or more transceivers for communicating with the WTRUs 132a, 132b, 132c over the air interface 146. In one embodiment, the eNode-Bs 170a, 170b, 170c may implement MIMO technology. Thus, the eNode-B 170a, for example, may use multiple antennas to transmit wireless signals to, and receive wireless signals from, the WTRU 132a.

Each of the eNode-Bs 170a, 170b, and 170c may be associated with a particular cell (not shown) and may be configured to handle radio resource management decisions, handover decisions, scheduling of users in the uplink and/or downlink, and the like. As shown in FIG. 11, the eNode-Bs 170a, 170b, 170c may communicate with one another over an X2 interface.

The core network 136 shown in FIG. 11 may include a mobility management gateway or entity (MME) 172, a serving gateway 174, and a packet data network (PDN) gateway 176. While each of the foregoing elements are depicted as part of the core network 136, it will be appreciated that any one of these elements may be owned and/or operated by an entity other than the core network operator.

The MME 172 may be connected to each of the eNode-Bs 170a, 170b, 170c in the RAN 134 via an S1 interface and may serve as a control node. For example, the MME 172 may be responsible for authenticating users of the WTRUs 132a, 132b, 132c, bearer activation/deactivation, selecting a particular serving gateway during an initial attach of the WTRUs 132a, 132b, 132c, and the like. The MME 172 may also provide a control plane function for switching between the RAN 134 and other RANs (not shown) that employ other radio technologies, such as GSM or WCDMA.

The serving gateway 174 may be connected to each of the eNode-Bs 170a, 170b, and 170c in the RAN 134 via the S1 interface. The serving gateway 174 may generally route and forward user data packets to/from the WTRUs 132a, 132b, 132c. The serving gateway 174 may also perform other functions, such as anchoring user planes during inter-eNode B handovers, triggering paging when downlink data is available for the WTRUs 132a, 132b, 132c, managing and storing contexts of the WTRUs 132a, 132b, 132c, and the like.

The serving gateway 174 may also be connected to the PDN gateway 176, which may provide the WTRUs 132a, 132b, 132c with access to packet-switched networks, such as the Internet 140, to facilitate communications between the WTRUs 132a, 132b, 132c and IP-enabled devices.

The core network 136 may facilitate communications with other networks. For example, the core network 136 may provide the WTRUs 132a, 132b, 132c with access to circuit-switched networks, such as the PSTN 138, to facilitate communications between the WTRUs 132a, 132b, 132c and traditional land-line communications devices. For example, the core network 136 may include, or may communicate with, an IP gateway (e.g., an IP multimedia subsystem (IMS) server) that serves as an interface between the core network 136 and the PSTN 138. In addition, the core network 136 may provide the WTRUs 132a, 132b, 132c with access to the networks 142, which may include other wired or wireless networks that are owned and/or operated by other service providers.

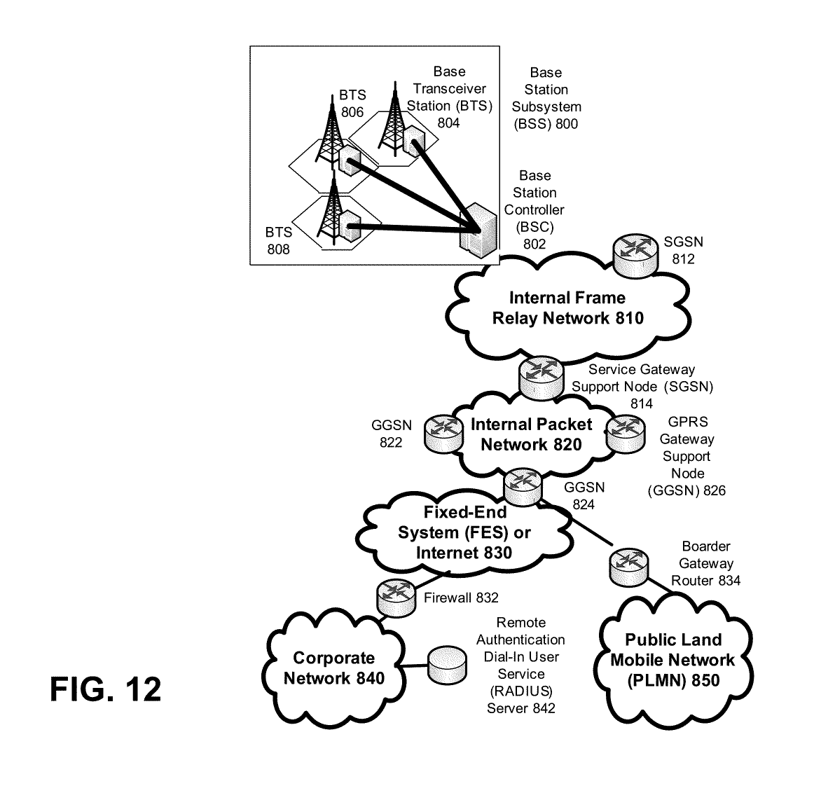

FIG. 12 depicts an overall block diagram of an example packet-based mobile cellular network environment, such as a GPRS network, within which an event based location-based service as described herein may be implemented and/or communicate with. In the example packet-based mobile cellular network environment shown in FIG. 12, there are a plurality of Base Station Subsystems (“BSS”) 800 (only one is shown), each of which comprises a Base Station Controller (“BSC”) 802 serving a plurality of Base Transceiver Stations (“BTS”) such as BTSs 804, 806, and 808. BTSs 804, 806, 808, etc. are the access points where users of packet-based mobile devices become connected to the wireless network. In example fashion, the packet traffic originating from user devices is transported via an over-the-air interface to a BTS 808, and from the BTS 808 to the BSC 802. Base station subsystems, such as BSS 800, are a part of internal frame relay network 810 that can include Service GPRS Support Nodes (“SGSN”) such as SGSN 812 and 814. Each SGSN is connected to an internal packet network 820 through which a SGSN 812, 814, etc. can route data packets to and from a plurality of gateway GPRS support nodes (GGSN) 822, 824, 826, etc. As illustrated, SGSN 814 and GGSNs 822, 824, and 826 are part of internal packet network 820. Gateway GPRS serving nodes 822, 824 and 826 mainly provide an interface to external Internet Protocol (“IP”) networks such as Public Land Mobile Network (“PLMN”) 850, corporate intranets 840, or Fixed-End System (“FES”) or the public Internet 830. As illustrated, subscriber corporate network 840 may be connected to GGSN 824 via firewall 832; and PLMN 850 is connected to GGSN 824 via boarder gateway router 834. The Remote Authentication Dial-In User Service (“RADIUS”) server 842 may be used for caller authentication when a user of a mobile cellular device calls corporate network 840.

Generally, there can be a several cell sizes in a GSM network, referred to as macro, micro, pico, femto and umbrella cells. The coverage area of each cell is different in different environments. Macro cells can be regarded as cells in which the base station antenna is installed in a mast or a building above average roof top level. Micro cells are cells whose antenna height is under average roof top level. Micro-cells are typically used in urban areas. Pico cells are small cells having a diameter of a few dozen meters. Pico cells are used mainly indoors. Femto cells have the same size as pico cells, but a smaller transport capacity. Femto cells are used indoors, in residential, or small business environments. On the other hand, umbrella cells are used to cover shadowed regions of smaller cells and fill in gaps in coverage between those cells.

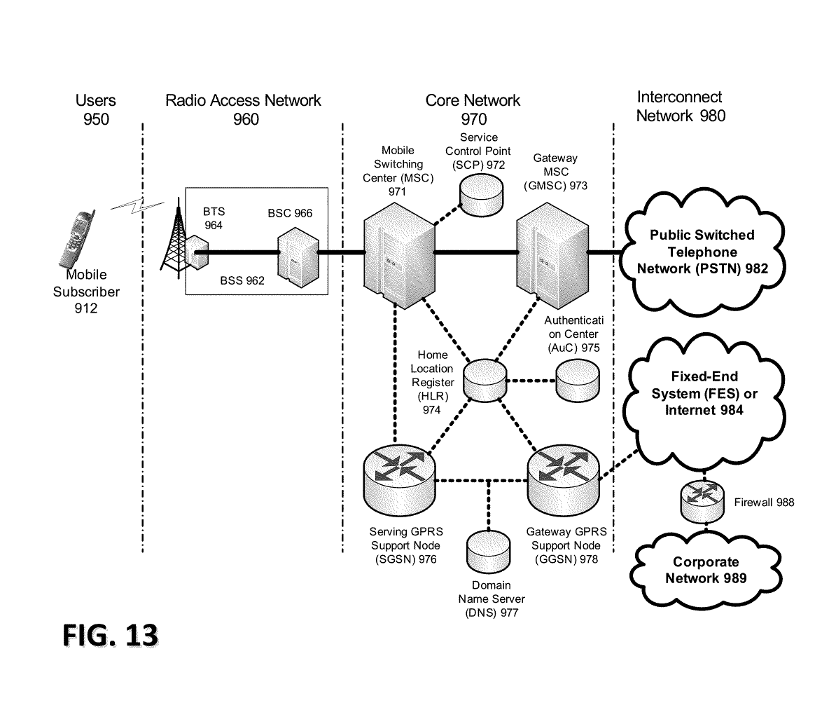

FIG. 13 illustrates an architecture of a typical GPRS network within which an event based location-based services as described herein may be implemented. The architecture depicted in FIG. 13 is segmented into four groups: users 950, radio access network 960, core network 970, and interconnect network 980. Users 950 comprise a plurality of end users. Note, device 912 is referred to as a mobile subscriber in the description of network shown in FIG. 13. In an example embodiment, the device depicted as mobile subscriber 912 comprises a communications device (e.g., communications device 100). Radio access network 960 comprises a plurality of base station subsystems such as BSSs 962, which include BTSs 964 and BSCs 966. Core network 970 comprises a host of various network elements. As illustrated in FIG. 13, core network 970 may comprise Mobile Switching Center (“MSC”) 971, Service Control Point (“SCP”) 972, gateway MSC 973, SGSN 976, Home Location Register (“HLR”) 974, Authentication Center (“AuC”) 975, Domain Name Server (“DNS”) 977, and GGSN 978. Interconnect network 980 also comprises a host of various networks and other network elements. As illustrated in FIG. 13, interconnect network 980 comprises Public Switched Telephone Network (“PSTN”) 982, Fixed-End System (“FES”) or Internet 984, firewall 988, and Corporate Network 989.

A mobile switching center can be connected to a large number of base station controllers. At MSC 971, for instance, depending on the type of traffic, the traffic may be separated in that voice may be sent to Public Switched Telephone Network (“PSTN”) 982 through Gateway MSC (“GMSC”) 973, and/or data may be sent to SGSN 976, which then sends the data traffic to GGSN 978 for further forwarding.

When MSC 971 receives call traffic, for example, from BSC 966, it sends a query to a database hosted by SCP 972. The SCP 972 processes the request and issues a response to MSC 971 so that it may continue call processing as appropriate.

The HLR 974 is a centralized database for users to register to the GPRS network. HLR 974 stores static information about the subscribers such as the International Mobile Subscriber Identity (“IMSI”), subscribed services, and a key for authenticating the subscriber. HLR 974 also stores dynamic subscriber information such as the current location of the mobile subscriber. Associated with HLR 974 is AuC 975. AuC 975 is a database that contains the algorithms for authenticating subscribers and includes the associated keys for encryption to safeguard the user input for authentication.

In the following, depending on context, the term “mobile subscriber” sometimes refers to the end user and sometimes to the actual portable device, such as a mobile device, used by an end user of the mobile cellular service. When a mobile subscriber turns on his or her mobile device, the mobile device goes through an attach process by which the mobile device attaches to an SGSN of the GPRS network. In FIG. 13, when mobile subscriber 912 initiates the attach process by turning on the network capabilities of the mobile device, an attach request is sent by mobile subscriber 912 to SGSN 976. The SGSN 976 queries another SGSN, to which mobile subscriber 912 was attached before, for the identity of mobile subscriber 912. Upon receiving the identity of mobile subscriber 912 from the other SGSN, SGSN 976 requests more information from mobile subscriber 912. This information is used to authenticate mobile subscriber 912 to SGSN 976 by HLR 974. Once verified, SGSN 976 sends a location update to HLR 974 indicating the change of location to a new SGSN, in this case SGSN 976. HLR 974 notifies the old SGSN, to which mobile subscriber 912 was attached before, to cancel the location process for mobile subscriber 912. HLR 974 then notifies SGSN 976 that the location update has been performed. At this time, SGSN 976 sends an Attach Accept message to mobile subscriber 912, which in turn sends an Attach Complete message to SGSN 976.

After attaching itself with the network, mobile subscriber 912 then goes through the authentication process. In the authentication process, SGSN 976 sends the authentication information to HLR 974, which sends information back to SGSN 976 based on the user profile that was part of the user's initial setup. The SGSN 976 then sends a request for authentication and ciphering to mobile subscriber 912. The mobile subscriber 912 uses an algorithm to send the user identification (ID) and password to SGSN 976. The SGSN 976 uses the same algorithm and compares the result. If a match occurs, SGSN 976 authenticates mobile subscriber 912.

Next, the mobile subscriber 912 establishes a user session with the destination network, corporate network 989, by going through a Packet Data Protocol (“PDP”) activation process. Briefly, in the process, mobile subscriber 912 requests access to the Access Point Name (“APN”), for example, UPS.com, and SGSN 976 receives the activation request from mobile subscriber 912. SGSN 976 then initiates a Domain Name Service (“DNS”) query to learn which GGSN node has access to the UPS.com APN. The DNS query is sent to the DNS server within the core network 970, such as DNS 977, which is provisioned to map to one or more GGSN nodes in the core network 970. Based on the APN, the mapped GGSN 978 can access the requested corporate network 989. The SGSN 976 then sends to GGSN 978 a Create Packet Data Protocol (“PDP”) Context Request message that contains necessary information. The GGSN 978 sends a Create PDP Context Response message to SGSN 976, which then sends an Activate PDP Context Accept message to mobile subscriber 912.

Once activated, data packets of the call made by mobile subscriber 912 can then go through radio access network 960, core network 970, and interconnect network 980, in a particular fixed-end system or Internet 984 and firewall 988, to reach corporate network 989

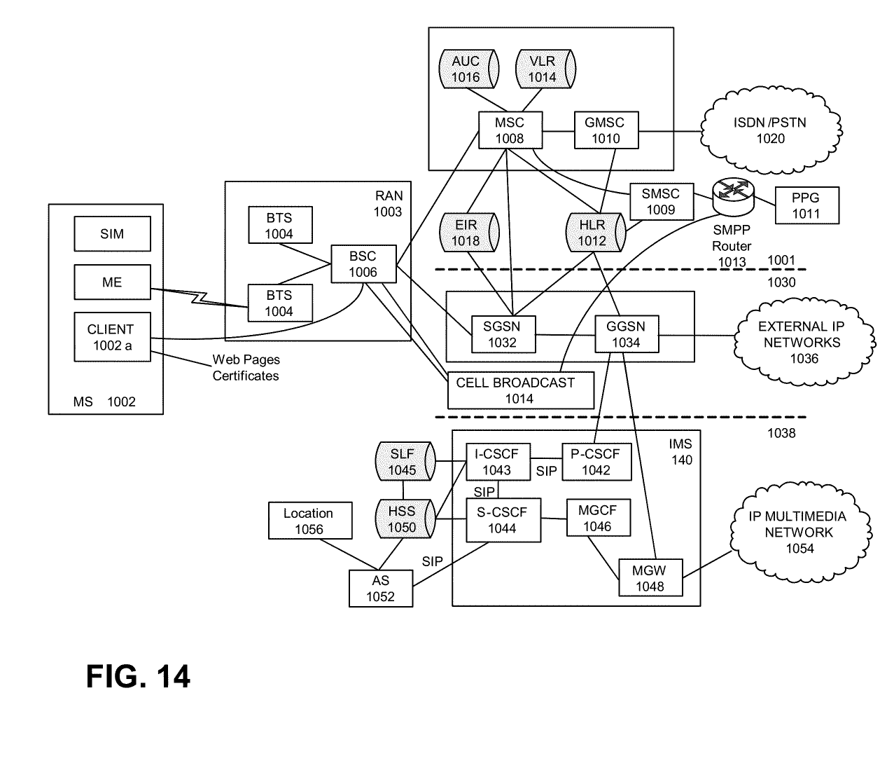

FIG. 14 illustrates an example block diagram view of a GSM/GPRS/IP multimedia network architecture within an event based location-based service as described herein may be implemented and/or communicate with. As illustrated, the architecture of FIG. 14 includes a GSM core network 1001, a GPRS network 1030 and an IP multimedia network 1038. The GSM core network 1001 includes a Mobile Station (MS) 1002, at least one Base Transceiver Station (BTS) 1004 and a Base Station Controller (BSC) 1006. The MS 1002 is physical equipment or Mobile Equipment (ME), such as a mobile phone or a laptop computer that is used by mobile subscribers, with a Subscriber identity Module (SIM) or a Universal Integrated Circuit Card (UICC). The SIM or UICC includes an International Mobile Subscriber Identity (IMSI), which is a unique identifier of a subscriber. The BTS 1004 is physical equipment, such as a radio tower, that enables a radio interface to communicate with the MS. Each BTS may serve more than one MS. The BSC 1006 manages radio resources, including the BTS. The BSC may be connected to several BTSs. The BSC and BTS components, in combination, are generally referred to as a base station (BSS) or radio access network (RAN) 1003.

The GSM core network 1001 also includes a Mobile Switching Center (MSC) 1008, a Gateway Mobile Switching Center (GMSC) 1010, a Home Location Register (HLR) 1012, Visitor Location Register (VLR) 1014, an Authentication Center (AuC) 1018, and an Equipment Identity Register (EIR) 1016. The MSC 1008 performs a switching function for the network. The MSC also performs other functions, such as registration, authentication, location updating, handovers, and call routing. The GMSC 1010 provides a gateway between the GSM network and other networks, such as an Integrated Services Digital Network (ISDN) or Public Switched Telephone Networks (PSTNs) 1020. Thus, the GMSC 1010 provides interworking functionality with external networks.

The HLR 1012 is a database that contains administrative information regarding each subscriber registered in a corresponding GSM network. The HLR 1012 also contains the current location of each MS. The VLR 1014 is a database that contains selected administrative information from the HLR 1012. The VLR contains information necessary for call control and provision of subscribed services for each MS currently located in a geographical area controlled by the VLR. The HLR 1012 and the VLR 1014, together with the MSC 1008, provide the call routing and roaming capabilities of GSM. The AuC 1016 provides the parameters needed for authentication and encryption functions. Such parameters allow verification of a subscriber's identity. The EIR 1018 stores security-sensitive information about the mobile equipment.

A Short Message Service Center (SMSC) 1009 allows one-to-one Short Message Service (SMS) messages to be sent to/from the MS 1002. A Push Proxy Gateway (PPG) 1011 is used to “push” (i.e., send without a synchronous request) content to the MS 1002. The PPG 1011 acts as a proxy between wired and wireless networks to facilitate pushing of data to the MS 1002. A Short Message Peer to Peer (SMPP) protocol router 1013 is provided to convert SMS-based SMPP messages to cell broadcast messages. SMPP is a protocol for exchanging SMS messages between SMS peer entities such as short message service centers. The SMPP protocol is often used to allow third parties, e.g., content suppliers such as news organizations, to submit bulk messages.

To gain access to GSM services, such as speech, data, and short message service (SMS), the MS first registers with the network to indicate its current location by performing a location update and IMSI attach procedure. The MS 1002 sends a location update including its current location information to the MSC/VLR, via the BTS 1004 and the BSC 1006. The location information is then sent to the MS's HLR. The HLR is updated with the location information received from the MSC/VLR. The location update also is performed when the MS moves to a new location area. Typically, the location update is periodically performed to update the database as location updating events occur.

The GPRS network 1030 is logically implemented on the GSM core network architecture by introducing two packet-switching network nodes, a serving GPRS support node (SGSN) 1032, a cell broadcast and a Gateway GPRS support node (GGSN) 1034. The SGSN 1032 is at the same hierarchical level as the MSC 1008 in the GSM network. The SGSN controls the connection between the GPRS network and the MS 1002. The SGSN also keeps track of individual MS's locations and security functions and access controls.

A Cell Broadcast Center (CBC) 14 communicates cell broadcast messages that are typically delivered to multiple users in a specified area. Cell Broadcast is one-to-many geographically focused service. It enables messages to be communicated to multiple mobile phone customers who are located within a given part of its network coverage area at the time the message is broadcast.

The GGSN 1034 provides a gateway between the GPRS network and a public packet network (PDN) or other IP networks 1036. That is, the GGSN provides interworking functionality with external networks, and sets up a logical link to the MS through the SGSN. When packet-switched data leaves the GPRS network, it is transferred to an external TCP-IP network 1036, such as an X.25 network or the Internet. In order to access GPRS services, the MS first attaches itself to the GPRS network by performing an attach procedure. The MS then activates a packet data protocol (PDP) context, thus activating a packet communication session between the MS, the SGSN, and the GGSN.

In a GSM/GPRS network, GPRS services and GSM services can be used in parallel. The MS can operate in one of three classes: class A, class B, and class C. A class A MS can attach to the network for both GPRS services and GSM services simultaneously. A class A MS also supports simultaneous operation of GPRS services and GSM services. For example, class A mobiles can receive GSM voice/data/SMS calls and GPRS data calls at the same time.

A class B MS can attach to the network for both GPRS services and GSM services simultaneously. However, a class B MS does not support simultaneous operation of the GPRS services and GSM services. That is, a class B MS can only use one of the two services at a given time.

A class C MS can attach for only one of the GPRS services and GSM services at a time. Simultaneous attachment and operation of GPRS services and GSM services is not possible with a class C MS.

A GPRS network 1030 can be designed to operate in three network operation modes (NOM1, NOM2 and NOM3). A network operation mode of a GPRS network is indicated by a parameter in system information messages transmitted within a cell. The system information messages dictates a MS where to listen for paging messages and how to signal towards the network. The network operation mode represents the capabilities of the GPRS network. In a NOM1 network, a MS can receive pages from a circuit switched domain (voice call) when engaged in a data call. The MS can suspend the data call or take both simultaneously, depending on the ability of the MS. In a NOM2 network, a MS may not receive pages from a circuit switched domain when engaged in a data call, since the MS is receiving data and is not listening to a paging channel. In a NOM3 network, a MS can monitor pages for a circuit switched network while received data and vice versa.

The IP multimedia network 1038 was introduced with 3GPP Release 5, and includes an IP multimedia subsystem (IMS) 1040 to provide rich multimedia services to end users. A representative set of the network entities within the IMS 1040 are a call/session control function (CSCF), a media gateway control function (MGCF) 1046, a media gateway (MGW) 1048, and a master subscriber database, called a home subscriber server (HSS) 1050. The HSS 1050 may be common to the GSM network 1001, the GPRS network 1030 as well as the IP multimedia network 1038.

The IP multimedia system 1040 is built around the call/session control function, of which there are three types: an interrogating CSCF (I-CSCF) 1043, a proxy CSCF (P-CSCF) 1042, and a serving CSCF (S-CSCF) 1044. The P-CSCF 1042 is the MS's first point of contact with the IMS 1040. The P-CSCF 1042 forwards session initiation protocol (SIP) messages received from the MS to an SIP server in a home network (and vice versa) of the MS. The P-CSCF 1042 may also modify an outgoing request according to a set of rules defined by the network operator (for example, address analysis and potential modification).

The I-CSCF 1043, forms an entrance to a home network and hides the inner topology of the home network from other networks and provides flexibility for selecting an S-CSCF. The I-CSCF 1043 may contact a subscriber location function (SLF) 1045 to determine which HSS 1050 to use for the particular subscriber, if multiple HSS's 1050 are present. The S-CSCF 1044 performs the session control services for the MS 1002. This includes routing originating sessions to external networks and routing terminating sessions to visited networks. The S-CSCF 1044 also decides whether an application server (AS) 1052 is required to receive information on an incoming SIP session request to ensure appropriate service handling. This decision is based on information received from the HSS 1050 (or other sources, such as an application server 1052). The AS 1052 also communicates to a location server 1056 (e.g., a Gateway Mobile Location Center (GMLC)) that provides a position (e.g., latitude/longitude coordinates) of the MS 1002.

The HSS 1050 contains a subscriber profile and keeps track of which core network node is currently handling the subscriber. It also supports subscriber authentication and authorization functions (AAA). In networks with more than one HSS 1050, a subscriber location function provides information on the HSS 1050 that contains the profile of a given subscriber.

The MGCF 1046 provides interworking functionality between SIP session control signaling from the IMS 1040 and ISUP/BICC call control signaling from the external GSTN networks (not shown). It also controls the media gateway (MGW) 1048 that provides user-plane interworking functionality (e.g., converting between AMR- and PCM-coded voice). The MGW 1048 also communicates with other IP multimedia networks 1054.

Push to Talk over Cellular (PoC) capable mobile phones register with the wireless network when the phones are in a predefined area (e.g., job site, etc.). When the mobile phones leave the area, they register with the network in their new location as being outside the predefined area. This registration, however, does not indicate the actual physical location of the mobile phones outside the pre-defined area.

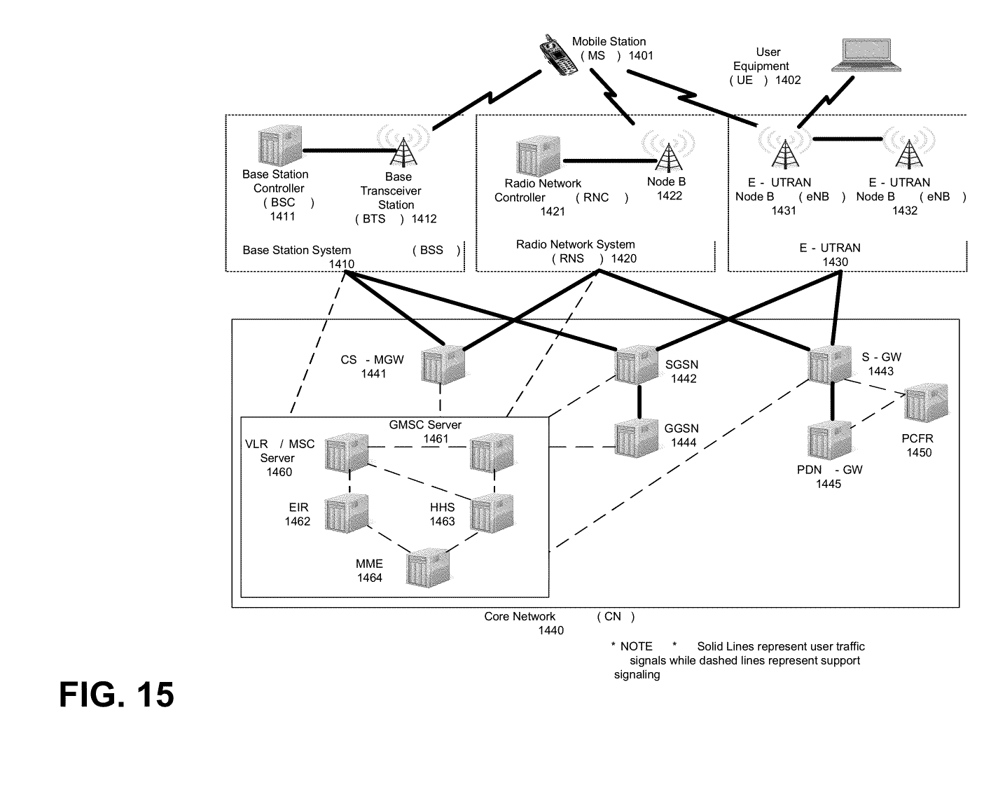

FIG. 15 illustrates a PLMN block diagram view of an example architecture in which an event based location-based service as described herein may be implemented and/or communicate with. Mobile Station (MS) 1401 is the physical equipment used by the PLMN subscriber. In one illustrative embodiment, communications device 200 may serve as Mobile Station 1401. Mobile Station 1401 may be one of, but not limited to, a cellular telephone, a cellular telephone in combination with another electronic device or any other wireless mobile communication device.

Mobile Station 1401 may communicate wirelessly with Base Station System (BSS) 1410. BSS 1410 contains a Base Station Controller (BSC) 1411 and a Base Transceiver Station (BTS) 1412. BSS 1410 may include a single BSC 1411/BTS 1412 pair (Base Station) or a system of BSC/BTS pairs which are part of a larger network. BSS 1410 is responsible for communicating with Mobile Station 1401 and may support one or more cells. BSS 1410 is responsible for handling cellular traffic and signaling between Mobile Station 1401 and Core Network 1440. Typically, BSS 1410 performs functions that include, but are not limited to, digital conversion of speech channels, allocation of channels to mobile devices, paging, and transmission/reception of cellular signals.

Additionally, Mobile Station 1401 may communicate wirelessly with Radio Network System (RNS) 1420. RNS 1420 contains a Radio Network Controller (RNC) 1421 and one or more Node(s) B 1422. RNS 1420 may support one or more cells. RNS 1420 may also include one or more RNC 1421/Node B 1422 pairs or alternatively a single RNC 1421 may manage multiple Nodes B 1422. RNS 1420 is responsible for communicating with Mobile Station 1401 in its geographically defined area. RNC 1421 is responsible for controlling the Node(s) B 1422 that are connected to it and is a control element in a UMTS radio access network. RNC 1421 performs functions such as, but not limited to, load control, packet scheduling, handover control, security functions, as well as controlling Mobile Station 1401's access to the Core Network (CN) 1440.

The evolved UMTS Terrestrial Radio Access Network (E-UTRAN) 1430 is a radio access network that provides wireless data communications for Mobile Station 1401 and User Equipment 1402. E-UTRAN 1430 provides higher data rates than traditional UMTS. It is part of the Long Term Evolution (LTE) upgrade for mobile networks and later releases meet the requirements of the International Mobile Telecommunications (IMT) Advanced and are commonly known as a 4G networks. E-UTRAN 1430 may include of series of logical network components such as E-UTRAN Node B (eNB) 1431 and E-UTRAN Node B (eNB) 1432. E-UTRAN 1430 may contain one or more eNBs. User Equipment 1402 may be any user device capable of connecting to E-UTRAN 1430 including, but not limited to, a personal computer, laptop, mobile device, wireless router, or other device capable of wireless connectivity to E-UTRAN 1430. The improved performance of the E-UTRAN 1430 relative to a typical UMTS network allows for increased bandwidth, spectral efficiency, and functionality including, but not limited to, voice, high-speed applications, large data transfer and IPTV, while still allowing for full mobility.

An example embodiment of a mobile data and communication service that may be implemented in the PLMN architecture described in FIG. 15 is the Enhanced Data rates for GSM Evolution (EDGE). EDGE is an enhancement for GPRS networks that implements an improved signal modulation scheme known as 8-PSK (Phase Shift Keying). By increasing network utilization, EDGE may achieve up to three times faster data rates as compared to a typical GPRS network. EDGE may be implemented on any GSM network capable of hosting a GPRS network, making it an ideal upgrade over GPRS since it may provide increased functionality of existing network resources. Evolved EDGE networks are becoming standardized in later releases of the radio telecommunication standards, which provide for even greater efficiency and peak data rates of up to 1 Mbit/s, while still allowing implementation on existing GPRS-capable network infrastructure.

Typically Mobile Station 1401 may communicate with any or all of BSS 1410, RNS 1420, or E-UTRAN 1430. In a illustrative system, each of BSS 1410, RNS 1420, and E-UTRAN 1430 may provide Mobile Station 1401 with access to Core Network 1440. The Core Network 1440 may include of a series of devices that route data and communications between end users. Core Network 1440 may provide network service functions to users in the Circuit Switched (CS) domain, the Packet Switched (PS) domain or both. The CS domain refers to connections in which dedicated network resources are allocated at the time of connection establishment and then released when the connection is terminated. The PS domain refers to communications and data transfers that make use of autonomous groupings of bits called packets. Each packet may be routed, manipulated, processed or handled independently of all other packets in the PS domain and does not require dedicated network resources.

The Circuit Switched-Media Gateway Function (CS-MGW) 1441 is part of Core Network 1440, and interacts with Visitor Location Register (VLR) and Mobile-Services Switching Center (MSC) Server 1460 and Gateway MSC Server 1461 in order to facilitate Core Network 1440 resource control in the CS domain. Functions of CS-MGW 1441 include, but are not limited to, media conversion, bearer control, payload processing and other mobile network processing such as handover or anchoring. CS-MGW 1440 may receive connections to Mobile Station 1401 through BSS 1410, RNS 1420 or both.

Serving GPRS Support Node (SGSN) 1442 stores subscriber data regarding Mobile Station 1401 in order to facilitate network functionality. SGSN 1442 may store subscription information such as, but not limited to, the International Mobile Subscriber Identity (IMSI), temporary identities, or Packet Data Protocol (PDP) addresses. SGSN 1442 may also store location information such as, but not limited to, the Gateway GPRS Support Node (GGSN) 1444 address for each GGSN where an active PDP exists. GGSN 1444 may implement a location register function to store subscriber data it receives from SGSN 1442 such as subscription or location information.

Serving Gateway (S-GW) 1443 is an interface which provides connectivity between E-UTRAN 1430 and Core Network 1440. Functions of S-GW 1443 include, but are not limited to, packet routing, packet forwarding, transport level packet processing, event reporting to Policy and Charging Rules Function (PCRF) 1450, and mobility anchoring for inter-network mobility. PCRF 1450 uses information gathered from S-GW 1443, as well as other sources, to make applicable policy and charging decisions related to data flows, network resources and other network administration functions. Packet Data Network Gateway (PDN-GW) 1445 may provide user-to-services connectivity functionality including, but not limited to, network-wide mobility anchoring, bearer session anchoring and control, and IP address allocation for PS domain connections.

Home Subscriber Server (HSS) 1463 is a database for user information, and stores subscription data regarding Mobile Station 1401 or User Equipment 1402 for handling calls or data sessions. Networks may contain one HSS 1463 or more if additional resources are required. Example data stored by HSS 1463 include, but is not limited to, user identification, numbering and addressing information, security information, or location information. HSS 1463 may also provide call or session establishment procedures in both the PS and CS domains.

The VLR/MSC Server 1460 provides user location functionality. When Mobile Station 1401 enters a new network location, it begins a registration procedure. A MSC Server for that location transfers the location information to the VLR for the area. A VLR and MSC Server may be located in the same computing environment, as is shown by VLR/MSC Server 1460, or alternatively may be located in separate computing environments. A VLR may contain, but is not limited to, user information such as the IMSI, the Temporary Mobile Station Identity (TMSI), the Local Mobile Station Identity (LMSI), the last known location of the mobile station, or the SGSN where the mobile station was previously registered. The MSC server may contain information such as, but not limited to, procedures for Mobile Station 1401 registration or procedures for handover of Mobile Station 1401 to a different section of the Core Network 1440. GMSC Server 1461 may serve as a connection to alternate GMSC Servers for other mobile stations in larger networks.

Equipment Identity Register (EIR) 1462 is a logical element which may store the International Mobile Equipment Identities (IMEI) for Mobile Station 1401. In a typical embodiment, user equipment may be classified as either “white listed” or “black listed” depending on its status in the network. In one embodiment, if Mobile Station 1401 is stolen and put to use by an unauthorized user, it may be registered as “black listed” in EIR 1462, preventing its use on the network. Mobility Management Entity (MME) 1464 is a control node which may track Mobile Station 1401 or User Equipment 1402 if the devices are idle. Additional functionality may include the ability of MME 1464 to contact an idle Mobile Station 1401 or User Equipment 1402 if retransmission of a previous session is required.

While example embodiments of an event based location-based service have been described in connection with various computing devices/processors, the underlying concepts may be applied to any computing device, processor, or system capable of implementing/utilizing an event based location-based service. The various techniques described herein may be implemented in connection with hardware or software or, where appropriate, with a combination of both. Thus, the methods and apparatuses of using and implementing an event based location-based service may be implemented, or certain aspects or portions thereof, can take the form of program code (i.e., instructions) embodied in concrete, tangible, storage media having a concrete, tangible, physical structure. Examples of tangible storage media include floppy diskettes, CD-ROMs, DVDs, hard drives, or any other tangible machine-readable storage medium (computer-readable storage medium). Thus, a computer-readable storage medium is not a transient signal per se. Further, a computer-readable storage medium is not a propagating signal per se. A computer-readable storage medium as described herein is an article of manufacture. When the program code is loaded into and executed by a machine, such as a computer, the machine becomes an apparatus for implementing an event based location-based service as described herein. In the case of program code execution on programmable computers, the computing device will generally include a processor, a storage medium readable by the processor (including volatile and non-volatile memory and/or storage elements), at least one input device, and at least one output device. The program(s) can be implemented in assembly or machine language, if desired. The language can be a compiled or interpreted language, and combined with hardware implementations.

The methods and apparatuses for using and implementing an event based location-based service as described herein also may be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes an apparatus for implementing an event based location-based service as described herein. When implemented on a general-purpose processor, the program code combines with the processor to provide a unique apparatus that operates to invoke the functionality of an event based location-based service as described herein.

While an event based location-based service has been described in connection with the various embodiments of the various figures, it is to be understood that other similar embodiments may be used or modifications and additions may be made to the described embodiments of an event based location-based service without deviating therefrom. For example, one skilled in the art will recognize that an event based location-based service as described in the instant application may apply to any environment, whether wired or wireless, and may be applied to any number of such devices connected via a communications network and interacting across the network. Therefore, an event based location-based service as described herein should not be limited to any single embodiment, but rather should be construed in breadth and scope in accordance with the appended claims.

What is claimed:

1. A method comprising:
receiving an indication of an event;
responsive to receiving the indication of the event:
determining a region associated with the event; and
determining a location of a device within the region;
determining an entity associated with the device; and
providing information about the device to the entity.

2. The method of claim 1, the event comprising an emergency event.

3. The method of claim 1, further comprising:
querying a profile database to determine the entity associated with the device.

4. The method of claim 1, wherein the entity is determined to be associated with the device based on a call history between the entity and the device.

5. The method of claim 1, wherein the entity is determined to be associated with the device based on subscription information regarding a person associated with the device.

6. The method of claim 1, wherein the entity is determined to be associated with the device based on a proximity of the device to the region.

7. The method of claim 1, the entity is determined to be associated with the device based on a location of the entity.

8. The method of claim 1, wherein the entity is determined to be associated with the device based on a relationship between a user of the device and at least one of:
the entity; or
a user of the entity.

9. The method of claim 1, further comprising updating a database with information regarding the association between the entity and the device.

10. An apparatus comprising:
a processor; and
memory coupled to the processor, the memory comprising executable instructions that when executed by the processor cause the processor to effectuate operations comprising:
receiving an indication of an event;
responsive to receiving the indication of the event:
determining a region of the event; and
determining a location of a device within the region;
determining an entity associated with the device; and
providing information about the device to the entity.

11. The apparatus of claim 10, the event comprising an emergency event.

12. The apparatus of claim 10, further comprising:
querying a profile database to determine the entity associated with the device.

13. The apparatus of claim 10, wherein the entity is determined to be associated with the device based on a call history between the entity and the device.

14. The apparatus of claim 10, wherein the entity is determined to be associated with the device based on subscription information regarding a person associated with the device.

15. The apparatus of claim 10, wherein the entity is determined to be associated with the device based on a proximity of the device to the region.

16. The apparatus of claim 10, the entity is determined to be associated with the device based on a location of the entity.

17. The apparatus of claim 10, wherein the entity is determined to be associated with the device based on a relationship between a user of the device and at least one of:
the entity; or
a user of the entity.

18. The apparatus of claim 10, further comprising updating a database with information regarding the association between the entity and the device.

19. A computer readable storage medium comprising executable instructions that when executed by a processor cause the processor to effectuate operations comprising:
receiving an indication of an event;
responsive to receiving the indication of the event:
determining a region of the event; and
determining a location of a device within the region;
determining an entity associated with the device; and
providing information about the device to the entity.

20. The computer readable storage medium of claim 19, wherein the entity is determined to be associated with the device based on subscription information regarding a person associated with the device.
